(19) United States
(12) Patent Application Publication
(10) Pub. No.: US 2016/0086086 A1
(43) Pub. Date: Mar. 24, 2016

(54) MULTI-MEDIA CONTENT-RECOMMENDER SYSTEM THAT LEARNS HOW TO ELICIT USER PREFERENCES

(71) Applicants: Victor Ferdinand Gabillon, Croix (FR); Branislav Kveton, San Jose, CA (US); Brian Eriksson, San Jose, CA (US)

(72) Inventors: Victor Ferdinand Gabillon, Croix (FR); Branislav Kveton, San Jose, CA (US); Brian Eriksson, San Jose, CA (US)

(21) Appl. No.: 14/489,703

(22) Filed: Sep. 18, 2014

(51) Int. Cl. G06N 5/04; G06N 7/00; G06N 99/00

(52) U.S. Cl. CPC G06N 5/04; G06N 99/005; G06N 7/00

(57) ABSTRACT

A recommendation system utilizes an optimistic adaptive submodular maximization (OASM) approach to provide recommendations to a user based on a minimized set of inquiries. Each inquiry's value relative to establishing user preferences is maximized to reduce the number of questions required to construct a recommendation engine for that user. The recommendation system does not require a priori knowledge of a user's preferences to optimize the recommendation engine.

### BACKGROUND

Most multimedia providers attempt in some form or fashion to include suggestions to their subscribers in hopes of increasing a subscriber's consumption of multimedia content. Since subscriptions are generally tied to revenue models that yield more monetary gain with increases in use, a system that can provide relevant suggestions to a user can dramatically increase sales. Typical systems employ techniques that use historical data associated with a user or groups of users to determine what they might like to view next. However, when these types of systems do not have access to historical data, they tend to slow down and suggest widely irrelevant selections until a user has progressed through a series of long questions or suggestions until the system has “learned” the user. This often frustrates the user and they quit using the system and seek out other means to find multimedia content to watch.

### SUMMARY

A method for providing recommendations to a user in a setting where the expected gain or value of a multimedia content suggestion is initially unknown is created using an adaptive process based on submodular maximization. This provides an efficient approach for making suggestions to a user in fewer steps, causing less aggravation to the user. The method is referred to as an Optimistic Adaptive Submodular Maximization (OASM) because it trades off exploration and exploitation based on the optimism in the face of the uncertainty principle.

In one embodiment, user preferences are elicited in a recommender system for multimedia content. The method presented includes the first near-optimal technique for learning how to elicit user preferences while eliciting them. Initially, the method has some uncertain model of the world based on how users tend to answer questions. When a new user uses the method, it elicits the preferences of the user based on a combination of the existing model and exploration, asking questions that may not be optimal but allows the method to learn how to better elicit preferences. The more the users use the method, the better the method becomes in preference elicitation and ultimately behaves near optimally in rapid time.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an example of a recommender system in accordance with an embodiment of the present principles.

FIG. 2 is comparison of three differing methods in accordance with an embodiment of the present principles.

FIG. 3 is an example of testing results in accordance with an embodiment of the present principles.

FIG. 4 is a method of recommending in accordance with an embodiment of the present principles.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

Maximization of submodular functions has wide applications in machine learning and artificial intelligence, such as social network analysis, sensor placement, and recommender systems. The problem of adaptive submodular maximization is discussed in detail below and is a variant of submodular maximization where each item has a state and this state is revealed when the item is chosen. The goal is to learn a policy that maximizes the expected return for choosing K items. Adaptive submodular maximization has been traditionally studied in a setting where the model of the world, the expected gain of choosing an item given previously selected items and their states, is known. This is the first method where the model is initially unknown, and it is learned by interacting repeatedly with the environment. The concepts of adaptive submodular maximization and bandits are brought together, and the result is an efficient solution to the problem.

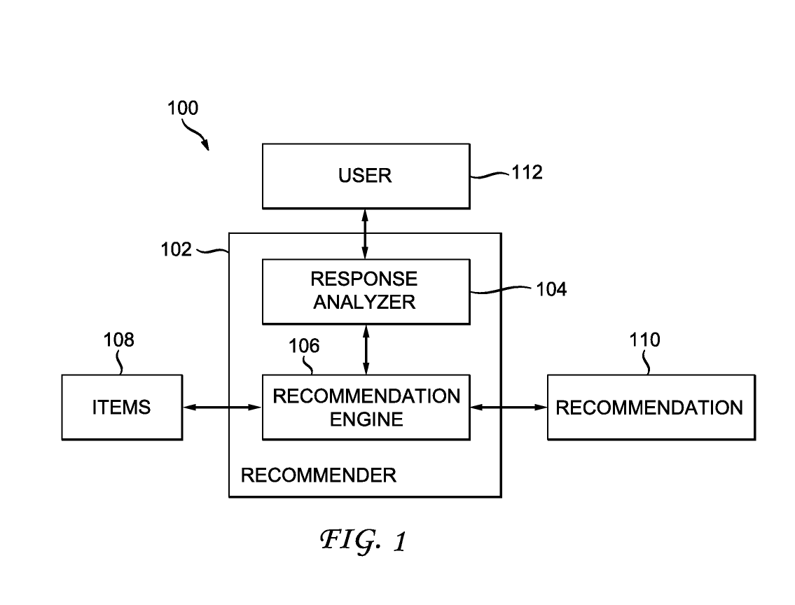

FIG. 1 one illustrates a recommendation system 100 that utilizes a recommender 102 having a response analyzer 104 and a recommendation engine 106 or policy. The recommender 102 finds items from an items database 108 to output as a recommendation 110. The items database 108 can include, but are not limited to, multimedia content such as audio and/or video content and the like and/or any items that can be associated with a person or other type of user (e.g., artificial intelligence system and the like). Thus, the recommendation system 100 can be used to suggest movies, music, books, other people (e.g., social networking, dating, etc.) and any grouping that has items that can be preferred over other items in the grouping. The recommendation engine 106 is incrementally created in a rapid fashion based on questions and responses analyzed by the response analyzer 104.

The recommendation engine 106 interacts with the response analyzer 104 to adaptively determine subsequent maximized diverse user inquiries based on prior user inputs to efficiently learn user preferences. The response analyzer 104 interacts with a user 112 to pose inquiries and receive responses from the user 112. Information derived from the user interactions facilitates in constructing the recommendation engine 106. The technique utilized by the recommender 102 allows for diverse questions to be asked of the user 112 in order to ascertain preferences as quickly as possible. This helps in greatly reducing user frustration when using the recommendation system 100 for the first time. The questions posed to the user 112 are vetted by the technique to optimally maximize the value of the question in relation to establishing the user's preferences in as few questions as possible. This means users can avoid putting in responses to a long list of canned questions such as “what is your gender, age, location, income, prior listening/watching habits, etc.”

For example, it could be determined that out of 100 types of music genres that a majority of users prefer one of three types—pop, country or rock. Thus, a first question with the greatest chance of finding a user's likes can be directed to which of these three genre types the user prefers, greatly narrowing down subsequent questions to the user. It is also possible that the user could also respond with “none” which means the assumption was incorrect. However, the question asking about the three genre types has the highest preference determination value in that it has a high probability that it can quickly narrow down the likes of the user and, therefore, is worth the risk that the user might respond with “none of the above.” The technique then continues to determine further questions that most rapidly lead to a proper recommendation. The method to employ this technique is discussed in detail as follows.

Four aspects of the method are explained. First, a model is used where the expected gain of choosing an item can be learned efficiently. The main assumption in the model is that the state of each item is distributed independently of the other states. Second, an Optimistic Adaptive Submodular Maximization (OASM), a bandit approach that selects items with the highest upper confidence bound on the expected gain is shown. This approach is computationally efficient and easy to implement. Third, the expected cumulative regret of the approach is proven to increase logarithmically with time. The regret bound captures the inherent property of adaptive submodular maximization, earlier mistakes are more costly than later ones. Finally, the method is applied to a real-world preference elicitation problem and shows that non-trivial policies can be learned from just a few hundred interactions with the problem.

In adaptive submodular maximization, the objective is to maximize, under constraints, a function of the form:

ƒᵢ2^{I}×{−1,1}^{L}→ [symbol] , (1)

where I={1, . . . , L} is a set of L items and 2^{I} is its power set. The first argument of ƒ is a subset of chosen items A⊂I. The second argument is the state φ ∈ {−1,1}^{L} of all items. The i-th entry of φ, φ[i], is the state of item i. The state φ is drawn i.i.d. from some probability distribution P(Φ). The reward for choosing items A in state φ is ƒ(A, φ). For simplicity of exposition, assume that ƒ(et, φ)=0 in all φ. In problems of interest, the state is only partially observed. To capture this phenomenon, the notion of observations is introduced. An observation is a vector y ∈ {−1,0,1}^{L} whose non-zero entries are the observed states of items. It is given that y is an observation of state φ, and write φ˜y, if y[i]=φ[i] in all non-zero entries of y. Alternatively, the state φ can be viewed as a realization of y, one of many. This is denoted by dom(y)={i:y[i]≠0] the observed items in y and by φ<A> the observation of items A in state φ. A partial ordering on observations is defined and written y^{•} [symbol] y if y^{•}[i]=y[i] in all non-zero entries of y, y^{•} is a more specific observation than y. In terminology of the art, y is a subrealization of y^{•}.

The notation is illustrated on a simple example. Let φ=(1,1−1) be a state, and y₁=(1,0,0) and y₂=(1,0,−1) be observations. Then all of the following claims are true:

φ˜y₁, φ˜y₂, y₂ [symbol] y₁, dom(y₂)={1,3}, φ<{1,3}>=y₂, φ<dom(y₁)>=y₁.

The goal is to maximize the expected value of ƒ by adaptively choosing K items. This problem can be viewed as a K step game, where at each step an item is chosen according to some policy π and then its state is observed. A policy πᵢ[1,0,1]^{b}>I is a function from observations y to items. The observations represent the past decisions and their outcomes. A k-step policy in state φ, πₖ(φ), is a collection of the first k items chosen by policy pi. The policy is defined recursively as:

πₖ(φ)=πₖ₋₁(φ)∪{π_{[k]}(φ)}, π_{[k]}(φ)=π(φ<πₖ₋₁(φ)>), π₀(φ)= (2)

where π_{[k]}(φ) is the k-th item chosen by policy π in state φ. The optimal if K-step policy satisfies:

$${π}^{*} = arg {max}_{π} {φ}_{} [ f ( {π}_{K} ( φ ) , φ ) ] . \qquad ( 3 )$$

In general, the problem of computing π* is NP-hard. However, near-optimal policies can be computed efficiently when the maximized function has a diminishing return property. Formally, it is required that the function is adaptive submodular and adaptive monotonic.

Definition 1. Function ƒ is adaptive submodular if: [symbol] _{φ}[ƒ(A∪{i}, φ)−ƒ(A, φ)[φ˜y_{A}]≧ [symbol] _{φ}[ƒ(B∪{i}, φ)−ƒ(B, φ)[φ˜y_{B}]

for all items i ∈ I\B and observations y_{B} [symbol] y_{A}, where A=dom(y_{A}) and B=dom(y_{B}).

Definition 2. Function ƒ is adaptive monotonic if: [symbol] _{φ}[ƒ(A∪{i}, φ)−ƒ(A, φ)[φ˜y_{A}]≧0 for all items i ∈ I\A and observations y_{A}, where A=dom(y_{A}).

In other words, the expected gain of choosing an item is always non-negative and does not increase as the observations become more specific. Let π^{g} be the greedy policy for maximizing ƒ, a policy that always selects the item with the highest expected gain:

$${π}^{g} ( y ) = {arg max}_{i ∈ I \backslash dom ( y )} {g}_{i} ( y ) , \qquad ( 4 )$$

where:

gᵢ(y)= [symbol] _{φ}[ƒ(dom(y)∪[i], φ)ƒ(dom(y), φ)[φ˜y] (5)

is the expected gain of choosing item i after observing y. Then, π^{g} is a (1−1/e)−approximation to π*, [symbol] _{φ[ƒ(π}_{K}^{g}(φ), φ)]≧(1−1/e) [symbol] _{φ}[ƒ(π_{K}*(φ), φ)], if ƒ is adaptive submodular and adaptive monotonic. It is established that an observation y is a context if it can be observed under the greedy policy π^{g}. Specifically, there exists k and φ such that y=φ<πₖ^{g}(φ)>.

Adaptive Submodularity in Bandit Setting

The greedy policy π^{g} can be computed only if the objective function ƒ and the distribution of states P(Φ) are known, because both of these quantities are needed to compute the marginal benefit gᵢ(y) (Equation 5). In practice, the distribution P(Φ) is often unknown, for instance in a newly deployed sensor network where the failure rates of the sensors are unknown. A natural variant of adaptive submodular maximization is explored that can model such problems. The distribution P(Φ) is assumed to be unknown and is learned by interacting repeatedly with the problem.

Recommendation Engine

The problem of learning P(Φ) can be cast in many ways. One approach is to directly learn the joint P(Φ). This approach is not practical for two reasons. First, the number of states φ is exponential in the number of items L. Second, the state of the problem is observed only partially. As a result, it is generally impossible to identify the distribution that generates φ. Another possibility is to learn the probability of individual states φ[i] conditioned on context, observations y under the greedy policy π^{g} in up to K steps. This is impractical because the number of contexts is exponential in K.

Clearly, additional structural assumptions are necessary to obtain a practical solution. It is assumed that the states of items are independent of the context in which the items are chosen. In particular, the state φ[i] of each item i is drawn i.i.d. from a Bernoulli distribution with mean pᵢ. In this setting, the joint probability distribution factors as:

$$P ( Φ = φ ) = {\prod }_{i = 1}^{L} {{p}_{i}^{1 ( φ [ i ] = 1 )} ( 1 - {p}_{i} )}^{1 - 1 ( φ [ i ] = 1 )} \qquad ( 6 )$$

and the problem of learning P(Φ) reduces to estimating L parameters, the means of the Bernoulli distributions. A question is how restrictive is the independence assumption. It is argued that this assumption is fairly natural in many applications. For instance, consider a sensor network where the sensors fail at random due to manufacturing defects. The failures of these sensors are independent of each other and, thus, can be modeled in the framework. To validate the assumption, an experiment is conducted that shows that it does not greatly affect the performance of the method on a real-world problem. Correlations obviously exist and are discussed below.

Based on the independence assumption, the expected gain (Equation 5) is rewritten as:

gᵢ(y)=pᵢ g̅ᵢ(y) (7)

where:

g̅ᵢ(y)= [symbol] _{φ}[ƒ(dom(y)∪{i}, Φ)−ƒ(dom(y), φ)[φ˜y,φ[i]=1] (8)

is the expected gain when item i is in state 1. For simplicity of exposition, it is assumed that the gain is zero when the item is in state −1.

In general, the g̅ᵢ(y) depends on P(Φ) and, thus, cannot be computed when P(Φ) is unknown. It is assumed that g̅ᵢ(y) can be computed without knowing P(Φ). This scenario is quite common in practice. In maximum coverage problems, for instance, it is quite reasonable to assume that the covered area is only a function of the chosen items and their states. In other words, the gain can be computed as g̅ᵢ(y)=ƒ(dom(y)∪{i}, φ)−⊕(ny,φ), where φ is any state such that φ˜y and φ[i]=1.

The learning problem comprises n episodes. In episode t, K items is adaptively chosen according to some policy π^{t}, which may differ from episode to episode. The quality of the policy is measured by the expected cumulative K-step return [symbol] _{φ, . . . , φ}_{ₙ} [umₜ₌₁ⁿƒ(π_{K}^{t}(φₜ), φₜ)]. This return is compared to that of the greedy policy π^{g} and measure the difference between the two returns by the expected cumulative regret:

$$R ( n ) = {{φ}_{1} , … , {φ}_{n}}_{} [ {\sum }_{i = 1}^{n} {R}_{t} ( {φ}_{t} ) ] = {{φ}_{1} , … , {φ}_{n}}_{} [ {\sum }_{i = 1}^{n} f ( {π}_{k}^{g} ( {φ}_{t} ) , {φ}_{t} ) - f ( {π}_{K}^{t} ( {φ}_{t} ) , {φ}_{t} ) ] . \qquad ( 9 )$$

In maximum coverage problems, the greedy policy π^{g} is a good surrogate for the optimal policy π* because it is a (1−1/e)−approximation to π*.

TABLE 1
Technique 1
Algorithm 1 OASM: Optimistic adaptive submolar maximization.

Input: States φ₁, . . . , φₙ

| | |
|---|---|
| for all i ∈ I do Select item i and set \hat{p}_{i,1} to its state, Tᵢ(0) ← 1 end for | [symbol] Initialization |

for all t = 1, 2, . . . , n do
A ←

| | |
|---|---|
| for all k = 1, 2, . . . , K do | [symbol] K-step maximization |

y ← φₜ

[symbol]

| | |
|---|---|
| $A ← A ⋃ \{ {arg max}_{i ∈ I ∖ A} ( {\hat{p}}_{i , {T}_{i} ( t - 1 )} + {c}_{t - 1 , {T}_{i} ( t - 1 )} ) {\overline{g}}_{i} ( y ) \}$ | [symbol] Choose the highest index |

end for

| | |
|---|---|
| for all i ∈ I do Tᵢ(t) ← Tᵢ(t − 1) end for | [symbol] Update statistics |

```
  for all i ∈ A do
    Tᵢ(t) ← Tᵢ(t) + 1
    ${\hat{p}}_{i , {T}_{i} ( t )} ← \frac{1}{{T}_{i} ( t )} ( {\hat{p}}_{i , {T}_{i} ( t - 1 )} {T}_{i} ( t - 1 ) + \frac{1}{2} ( {φ}_{t} [ i ] + 1 ) )$
  end for
end for
```

The technique is designed based on the optimism in the face of uncertainty principle, a strategy that is at the core of many bandit approaches. More specifically, it is a greedy policy where the expected gain gᵢ(y) (Equation 7) is substituted for its optimistic estimate. The technique adaptively maximizes a submodular function in an optimistic fashion and therefore it is referred to as Optimistic Adaptive Submodular Maximization (OASM).

The pseudocode of the method is given in Table 1: Technique 1 above. In each episode, the function ƒ is maximized in K steps. At each step, the index (\hat{p}_{i,T}_{ᵢ}₍ₜ₋₁₎+c_{t-1,T}_{ᵢ}₍ᵢ₋₁₎) g̅ᵢ(y)(\hat{p}_{i,T}_{_{i(t−1)}}) g̅ᵢ( ) of each item that has not been selected yet is computed and then choose the item with the highest index. The terms p̅_{i,T}_{_{i(t−1)}} and c_{t-1,T}_{_{i(t−1)}} are the maximum-likelihood estimate of the probability pᵢ from the first t−1 episodes and the radius of the confidence interval around this estimate, respectively. Formally:

$${\hat{p}}_{i , s} = \frac{1}{s} {\sum }_{z = 1}^{s} \frac{1}{2} ( {φ}_{τ ( i , z )} [ i ] + 1 ) , \\ {c}_{t , s} = \sqrt{\frac{2 log ( t )}{s}} , \qquad ( 10 )$$

where s is the number of times that item i is chosen and τ(i,z) is the index of the episode in which item i is chosen for the z-th time. In episode t, set s to Tᵢ(t−1), the number of times that item i is selected in the first t−1 episodes. The radius c_{t,s} is designed such that each index is with high probability an upper bound on the corresponding gain. The index enforces exploration of items that have not been chosen very often. As the number of past episodes increases, all confidence intervals shrink and the method starts exploiting most profitable items. The log (t) term guarantees that each item is explored infinitely often as t→∞, to avoid linear regret.

Approach OASM has several notable properties. First, it is a greedy method. Therefore, the policies can be computed very fast. Second, it is guaranteed to behave near optimally as the estimates of the gain gᵢ(y) become more accurate. Finally, the technique learns only L parameters and, therefore, is quite practical. Specifically, note that if an item is chosen in one context, it helps in refining the estimate of the gain gᵢ( ) in all other contexts.

Analysis

An upper bound on the expected cumulative regret of approach OASM in n episodes is shown. Before the main result is presented, notation used in the analysis is defined. It is denoted by i*(y)=π^{g}(y) the item chosen by the greedy policy π^{g} in context y. Without loss of generality, it is assumed that this item is unique in all contexts. The hardness of discriminating between items i and i*(y) is measured by a gap between the expected gains of the items:

Δᵢ(y)=gᵢ·(y)(y)gᵢ(y). (11)

The analysis is based on counting how many times the policies π^{t} and π^{g} choose a different item at step k. Therefore, several variables are defined that describe the state of the problem at this step. It is denoted by [symbol] ₖ(π)=∪_{φ}{φ<πₖ₋₁(φ)>} the set of all possible observations after policy π is executed for k−1 steps. It is written [symbol] ₖ= [symbol] ₖ(π^{g}) and [symbol] ₖ^{t}= [symbol] ₖ(π^{t}) when the policies π^{g} and π^{t} are referred to, respectively. Finally, it is denoted by [symbol] _{k,i}= [symbol] ₖ ∩{y:i≠i*(y)} the set of contexts where items is suboptimal at step k.

The main result is Theorem 1. The terms item and arm are treated as synonyms, and whichever is more appropriate in a given context is used.

Theorem 1. The expected cumulative regret of approach OASM is bounded as:

$$R ( n ) \leq \underbrace{{\sum }_{i = 1}^{L} {𝓁}_{i} {\sum }_{k = 1}^{K} {G}_{k} {α}_{i , k}}_{O ( log n )} + \underbrace{\frac{2}{3} {π}^{2} L ( L + 1 ) {\sum }_{k = 1}^{K} {G}_{k} ,}_{O ( 1 )} \qquad ( 12 )$$

where Gₖ=(K−k+1)max_{y∈} [symbol] _{ₖ} maxᵢgᵢ(y) is an upper bound on the expected gain of the policy π^{g} from step k forward,

$${𝓁}_{i , k} = ⌈ 8 {max}_{y ∈ {𝓎}_{k , i}} \frac{{g}_{i}^{s} ( y )}{{Δ}_{i}^{s} ( y )} log n ⌉$$

is the number of pulls after which arm i is not likely to be pulled suboptimally at step k, lᵢ=maxₖ l_{i,k}, and

$${α}_{i , k} = {\frac{1}{{𝓁}_{i}} [ {𝓁}_{i , k} - {max}_{k < k} {𝓁}_{i , k} ]}^{+} ∈ [ 0 , 1 ]$$

is a weight that associates the regret of arm i to step k such that Σₖ₌₁^{K} α_{i,k}=1.

Proof. The theorem is proved in three steps. First, the regret in episode t is associated with the first step where the policy π^{t} selects a different item from the greedy policy π^{g}. For simplicity, suppose that this step is step k. Then the regret in episode t can be written as:

$${R}_{t} ( {φ}_{t} ) - f ( {π}_{k}^{g} ( {φ}_{t} ) , {φ}_{t} ) - f ( {π}_{k}^{t} ( {φ}_{t} ) , {φ}_{t} ) = \underbrace{f ( {π}_{k}^{g} ( {φ}_{t} ) , {φ}_{t} ) f ( {π}_{k - 1}^{g} ( {φ}_{t} ) , {φ}_{t} )}_{{F}_{k \to }^{g} ( {φ}_{t} )} [ \underbrace{f ( {π}_{k}^{t} ( {φ}_{t} ) , {φ}_{t} ) f ( {π}_{k - 1}^{t} ( {φ}_{t} ) , {φ}_{t} )}_{{F}_{k \to }^{t} ( {φ}_{t} )} ] , \qquad ( 13 )$$

where the last equality is due to the assumption that π_{[j]}^{g}(φₜ)=π_{[j]}(φₜ) for all j<k; and F_{k→}^{g}(φₜ) and F_{k→}^{t}(φₜ) are the gains of the policies π^{g} and π^{t}, respectively, in state φₜ from step k forward. In practice, the first step where the policies π^{t} and π^{g} choose a different item is unknown, because π^{g} is unknown. In this case, the regret can be written as:

$${R}_{t} ( {φ}_{t} ) = {\sum }_{i = 1}^{L} {\sum }_{k = 1}^{K} {1}_{i , k , t} ( {φ}_{t} ) ( {F}_{k \to }^{g} ( {φ}_{t} ) - {F}_{k \to }^{t} ( {φ}_{t} ) ) , \qquad ( 14 )$$

where:

1_{i,k,t}(φ)=1{(∀j<k: π_{[j]}^{t}(φ)), π_{[k]}^{t}(φ)≠π_{[k]}^{g}(φ), π_{[k]}^{t}(φ)=i} (15)

is the indicator of the event that the policies π^{t} and π^{g} choose the same first k−1 items in state φ, disagree in the k-th item, and i is the k-th item chosen by π^{t}. The commas in the indicator function represent logical conjunction.

Second, the expected loss associated with choosing the first different item at step k is bound by the probability of this event and an upper bound on the expected loss Gₖ, which does not depend on π^{t} and φₜ. Based on this result, the expected cumulative regret is bound as:

$$\begin{matrix}{{φ}_{1} , … , {φ}_{n}}_{} [ {\sum }_{t = 1}^{n} {R}_{t} ( {φ}_{t} ) ] = {{φ}_{1} , … , {φ}_{n}}_{} [ {\sum }_{t = 1}^{n} {\sum }_{i = 1}^{L} {\sum }_{k = 1}^{K} {L}_{i , k , t} ( {φ}_{t} ) ( {F}_{k \to }^{g} ( {φ}_{t} ) - {F}_{k \to }^{t} ( {φ}_{t} ) ) ] \\ = {\sum }_{i = 1}^{L} {\sum }_{k = 1}^{K} {\sum }_{t = 1}^{n} {{φ}_{1} , … , {φ}_{t - 1}}_{} [ {{φ}_{t}}_{} [ {1}_{i , k , t} ( {φ}_{t} ) ( {F}_{k \to }^{g} ( {φ}_{t} ) - {F}_{k \to }^{t} ( {φ}_{t} ) ) ] ] \\ \leq {\sum }_{i = 1}^{L} {\sum }_{k = 1}^{K} {\sum }_{t = 1}^{n} {{φ}_{1} , … , {φ}_{t - 1}}_{} [ {{φ}_{t}}_{} [ {1}_{i , k , t} ( {φ}_{t} ) ] {G}_{k} ] \\ = {\sum }_{i = 1}^{L} {\sum }_{k = 1}^{K} {G}_{k} {{φ}_{1} , … , {φ}_{n}}_{} [ {\sum }_{t = 1}^{n} {1}_{i , k , t} ( {φ}_{t} ) ] .\end{matrix} \qquad ( 16 )$$

Finally, motivated by the analysis of UCB1, the indicator 1_{i,k,t}(φₜ) is rewritten as:

1_{i,k,t}(φₜ)=1_{i,k,t}(φₜ)1{Tᵢ(t−1)≦l_{i,k}}+1_{i,k,t}(φₜ)1{Tᵢ(t−1)>l_{i,k}}. (17)

where l_{i,k} is a problem-specific constant. l_{i,k} is chosen such that arm i at step k is pulled suboptimally a constant number of times in expectation after l_{i,k} pulls. Based on this result, the regret corresponding to the events 1{Tᵢ(t−1)>l_{i,k}} is bounded as:

$${\sum }_{i = 1}^{L} {\sum }_{k = 1}^{K} {G}_{k} {{φ}_{1} , … , {φ}_{n}}_{} [ {\sum }_{t = 1}^{n} {1}_{i , k , t} ( {φ}_{t} ) 1 \{ {T}_{i} ( t - 1 ) > {𝓁}_{i , k} \} ] \leq L ( L + 1 ) \frac{{π}^{2}}{6} {\sum }_{k = 1}^{K} {G}_{k} . \qquad ( 18 )$$

On the other hand, the regret associated with the events 1{Tᵢ(t−1)≦l_{i,k}} is trivially bounded by Σᵢ₌₁^{L} Σₖ₌₁^{K} Gₖ l_{i,k}. A tighter upper bound is proved below:

$${\sum }_{i = 1}^{L} {{φ}_{1} , … , {φ}_{n}}_{} [ {\sum }_{k = 1}^{K} {G}_{k} {\sum }_{t = 1}^{n} {1}_{i , k , t} ( {φ}_{t} ) 1 \{ {T}_{i} ( t - 1 ) \leq {𝓁}_{i , k} \} ] \leq {\sum }_{i = 1}^{L} {max}_{{φ}_{1} , … , {φ}_{n}} [ {\sum }_{k = 1}^{K} {G}_{k} {\sum }_{t = 1}^{n} {1}_{i , k , t} ( {φ}_{t} ) 1 \{ {T}_{i} ( t - 1 ) \leq {𝓁}_{i , k} \} ] \leq {\sum }_{i = 1}^{L} {\sum }_{k = 1}^{K} {{G}_{k} [ {𝓁}_{i , k} - {max}_{{k}^{′} < k} {𝓁}_{i , {k}^{′}} ]}^{+} . \qquad ( 19 )$$

The last inequality can be proved as follows. The upper bound on the expected loss at step k, Gₖ, is monotonically decreasing with k, and therefore G₁≧G₂≧ . . . ≧ G_{K}. So for any given arm i, the highest cumulative regret subject to the constraint Tᵢ(t−1)≦l_{i,k} at step k is achieved as follows. The first l_{i,1} mistakes are made at the first step, [l_{i,2}−l_{i,1}]^{→} mistakes are made at the second step, [l_{i,3}−max {ll_{i,1}, l_{i,2}}]^{←} mistakes are made at the third step, and so on. Specifically, the number of mistakes at step k is [l_{i,k}−maxₖ_{^{•}}_{<k}l_{i,k}_{^{•}}]^{←} and the associated loss is Gₖ. The main claim follows from combining the upper bounds in Equations 18 and 19.

Approach OASM mimics the greedy policy π^{g}. Therefore, it was decided to prove Theorem 1 based on counting how many times the policies π^{t} and π^{g} choose a different item. The proof has three parts. First, associate the regret in episode t with the first step where the policy π^{t} chooses a different item from π^{g}. Second, bound the expected regret in each episode by the probability of deviating from the policy π^{g} at step k and an upper bound on the associated loss Gₖ, which depends only on k. Finally, divide the expected cumulative regret into two terms, before and after item i at step k is selected a sufficient number of times l_{i,k}, and then set l_{i,k} such that both terms are O(log n). It is stressed that the proof is relatively general. In the rest of the proof, it is only assumed that ƒ is adaptive submodular and adaptive monotonic.

The regret bound has several notable properties. First, it is logarithmic in the number of episodes n, through problem-specific constants l_{i,k}. So, a classical result is recovered from the bandit literature. Second, the bound is polynomial in all constants of interest, such as the number of items L and the number of maximization steps K in each episode. It is stressed that it is not linear in the number of contexts Y_{K} at step K, which is exponential in K. Finally, note that the bound captures the shape of the optimized function ƒ. In particular, because the function ƒ is adaptive submodular, the upper bound on the gain of the policy π^{g} from step k forward, G_{L}, decreases as k increases. As a result, earlier deviations from π^{g} are penalized more than later ones.

Experiments

The approach is evaluated on a preference elicitation problem in a movie recommendation domain. This problem is cast as asking K yes-or-no movie-genre questions. The users and their preferences are extracted from the MovieLens dataset, a dataset of 6 k users who rated one million movies. The 500 most rated movies were chosen from the dataset. Each movie l is represented by a feature vector xₗ such that xₗ[i]=1 if the movie belongs to genre i and xₗ[i]=0 if it does not. The preference of user j for genre i is measured by tf-idf, a popular importance score in information retrieval. In particular, it is defined as

$$tf - 1 df ( j , t ) = \# ( j , t ) log ( \frac{{n}_{u}}{\# ( \cdot , i )} ) ,$$

where #(j, i) is the number of movies from genre i rated by user j, nᵤ is the number of users, and #(•, i) is the number of users that rated at least one movie from genre i. Intuitively, this score prefers genres that are often rated by the user but rarely rated overall. Each user j is represented by a genre preference vector φ such that φ[i]=1 when genre is among five most favorite genres of the user. These genres cover on average 25% of the selected movies. In Table 2, several popular genres from the selected dataset are shown. These include eight movie genres that cover the largest number of movies in expectation.

TABLE 2
Popular Genres Selected

| Genre | gᵢ (0) | g̅ᵢ (0) | P (φ[i] = 1) |
|---|---|---|---|
| Crime | 4.1% | 13.0% | 0.32 |
| Children's | 4.1% | 9.2% | 0.44 |
| Animation | 3.2% | 6.6% | 0.48 |
| Horror | 3.0% | 8.0% | 0.38 |
| Sci-Fi | 2.8% | 23.0% | 0.12 |
| Musical | 2.6% | 6.0% | 0.44 |
| Fantasy | 2.6% | 5.8% | 0.44 |
| Adventure | 2.3% | 19.6% | 0.12 |

The reward for asking user φ questions A is:

$$f ( A , φ ) = \frac{1}{5} {\sum }_{i = 1}^{500} {max}_{i} [ {x}_{i} [ i ] 1 \{ φ [ i ] = 1 \} 1 \{ i ∈ A \} ] , \qquad ( 20 )$$

the percentage of movies that belong to at least one genre i that is preferred by the user and queried in A. The function ƒ captures the notion that knowing more preferred genres is better than knowing less. It is submodular in A for any given preference vector φ, and therefore adaptive submodular in A when the preferences are distributed independently of each other (Equation 6). In this setting, the expected value of ƒ can be maximized near optimally by a greedy policy (Equation 4).

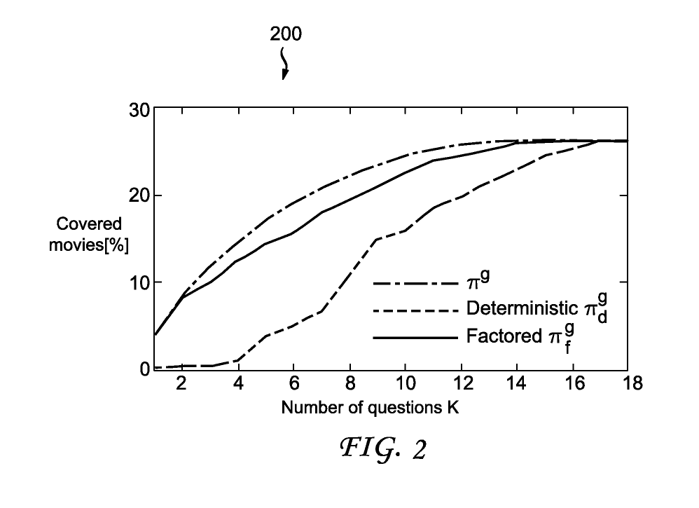

In the first experiment, it is shown that the assumption on P(Φ) (Equation 6) is not very restrictive in the domain. Three greedy policies for maximizing ƒ that know P(Φ) are compared and differ in how the expected gain of choosing items is estimated. The first policy π^{g} makes no assumption on P(Φ) and computes the gain according to Equation 5. The second policy π_{f}^{g} assumes that the distribution P(Φ) is factored and computes the gain using Equation 7. Finally, the third policy π_{d}^{g} computes the gain according to Equation 8, essentially ignoring the stochasticity of the problem. All policies are applied to all users in the dataset for all K≦L and their expected returns are reported in FIG. 2. In FIG. 2, a chart 200 illustrates the comparison of the three greedy policies for solving the preference elicitation problem. For each policy and K≦L, the expected percentage of covered movies after K questions is depicted. Two trends are observed. First, the policy π_{f}^{g} usually outperforms the policy π_{d}^{g} by a large margin. So although the independence assumption may be incorrect, it is a better approximation than ignoring the stochastic nature of the problem. Second, the expected return of π_{f}^{g} is always within 84% of π^{g}. It is concluded that π_{f}^{g} is a good approximation to π^{g}.

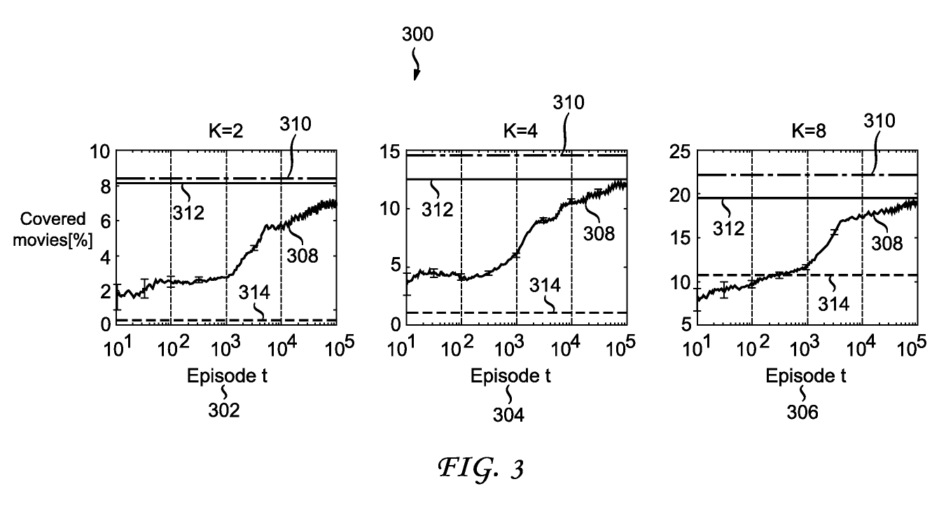

In the second experiment, how the OASM policy π^{t} improves over time is studied. In each episode t, a new user φ^{t} is randomly chosen and then the policy π^{t} asks K questions. The expected return of π^{t} is compared to two offline baselines, π_{f}^{g} and π_{d}^{g}. The policies π_{f}^{g} and π_{d}^{g} can be viewed as upper and lower bounds on the expected return of π^{t}, respectively. The results are shown in graphs 302-306 of example 300 in FIG. 3. The expected return of the OASM policy π^{t} 308 in all episodes up to t=10⁵. The return is compared to those of the greedy policies π^{g} 310, π_{f}^{g} 312 and π_{d}^{g} 314 in the offline setting (FIG. 2) at the same operating point, the number of asked questions K. Two major trends are observed. First, π^{t} easily outperforms the baseline π_{d}^{g} that ignores the stochasticity of the problem. In two cases, this happens in less than ten episodes. Second, the expected return of π^{t} approaches that of πₘƒ^{g}, as is expected based on the analysis.

The methods described above use adaptive submodular maximization in a setting where the model of the world is initially unknown. The methods include an efficient bandit technique for solving the problem and prove that their expected cumulative regrets increases logarithmically with time. This is an example of reinforcement learning (RL) for adaptive submodularity. The main difference in the setting is that near-optimal policies can be learned without estimating the value function. Learning of value functions is typically hard, even when the model of the problem is known. This is not necessary in the problem and, therefore, a very efficient learning methods are given.

It was assumed that the states of items are distributed independently of each other. In the experiments, this assumption was less restrictive than expected. Nevertheless, the methods are utilized under less restrictive assumptions. In preference elicitation, for instance, the answers to questions are likely to be correlated due to many factors, such as user's preferences, user's mood, and the similarity of the questions. The methods above are quite general and can be extended to more complex models. Such a generalization would comprise three major steps: choosing a model, deriving a corresponding upper confidence bound on the expected gain, and finally proving an equivalent.

It is assumed that the expected gain of choosing an item (Equation 7) can be written as a product of some known gain function (Equation 8) and the probability of the item's states. This assumption is quite natural in maximum coverage problems but may not be appropriate in other problems, such as generalized binary search. The upper bound on the expected regret at step can be loose in practice because it is obtained by maximizing over all contexts. In general, it is difficult to prove a tighter bound. Such a bound would have to depend on the probability of making a mistake in a specific context at step k, which depends on the policy in that episode, and indirectly on the progress of learning in all earlier episodes.

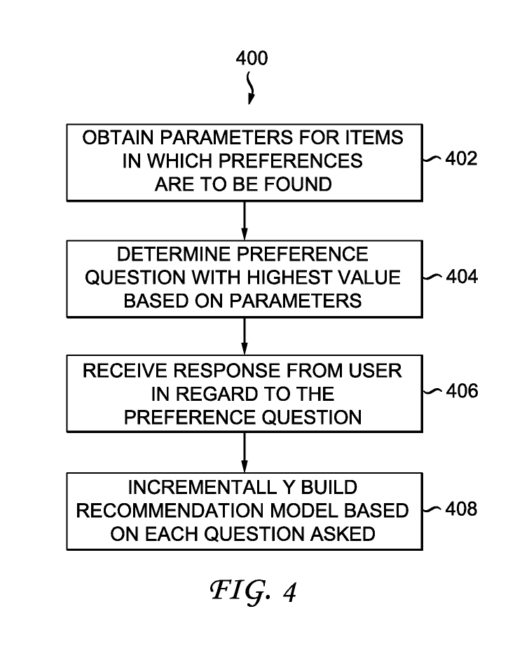

In view of the exemplary systems shown and described above, methodologies that can be implemented in accordance with the embodiments will be better appreciated with reference to the flow chart of FIG. 4. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 4 is a flow diagram of a method 400 of establishing a recommendation engine. The method 400 begins by obtaining parameters for items in which preferences are to be found 402. This includes, but is not limited to, obtaining parameters such as, for example, most favored items in an item grouping, most selected items in an item grouping, and the like. It can also include parameters such as subgroups such as genre and the like. The OASM approach is then employed to determine a preference question with the highest preference determination value based on the parameters 404. The objective is to ask the fewest amount of questions of a user while still providing relevant recommendations. A response is received from a user 406 and is utilized to incrementally construct a recommendation engine for that user based on each asked question 408. The OASM approach maximizes the preference value of each asked question such that the model is built as quickly as possible. This drastically reduces user frustrations when they first begin using the recommender. Examples of types of recommending systems have been described above. However, the method of constructing a recommender model is not limited to those examples.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations. Furthermore, to the extent that the term “includes” is used in either the detailed description or the claims, such term is intended to be inclusive in a manner similar to the term “comprising” as “comprising” is interpreted when employed as a transitional word in a claim.

1. A recommendation system, comprising:
an analyzer that receives and interprets at least one response to at least one inquiry asked of a user related to a group of items; and
a recommendation engine that makes recommendations based on the user responses, the recommendation engine adaptively determines subsequent maximized diverse user inquiries based on prior user responses to learn user preferences to provide recommendations of items in the group to that user.

2. The system of claim 1, wherein the group of items comprising multimedia content.

3. The system of claim 2, wherein the group of items comprising at least one from the group consisting of movies and music.

4. The system of claim 1, wherein the recommendation engine obtains parameters for the group of items to assist in selecting at least one user inquiry.

5. The system of claim 1, wherein the recommendation engine uses an optimistic adaptive submodular maximization method to determine inquiries for a user.

6. The system of claim 1, wherein the user is an artificial intelligence.

7. The system of claim 1, wherein the user is a first time user.

8. The system of claim 1 builds a recommendation engine for each user.

9. A server, comprising:
an analyzer that receives and interprets at least one response to at least one inquiry asked of a user related to a group of items; and
a recommendation engine that makes recommendations based on the user responses, the recommendation engine adaptively determines subsequent maximized diverse user inquiries based on prior user responses to learn user preferences to provide recommendations of items in the group to that user.

10. A mobile device, comprising:
an analyzer that receives and interprets at least one response to at least one inquiry asked of a user related to a group of items; and
a recommendation engine that makes recommendations based on the user responses, the recommendation engine adaptively determines subsequent maximized diverse user inquiries based on prior user responses to learn user preferences to provide recommendations of items in the group to that user.

11. A method for recommending items, comprising:
receiving an input from a user in response to an inquiry related to a group of items; and
creating an item recommendation engine based on the received input, the engine adaptively determining subsequent maximized diverse user inquiries based on prior user inputs to learn user preferences to provide recommendations of items from the group of items.

12. The method of claim 11, further comprising:
obtaining parameters for the group of items to assist in selecting at least one user inquiry.

13. The method of claim 11, further comprising:
determining inquiries for a user by using an optimistic adaptive submodular maximization method.

14. The method of claim 11, further comprising:
creating an item recommendation engine for each user.

15. The method of claim 11, wherein the group of items represent multimedia content.

16. The method of claim 15, wherein the group of items comprising at least one from the group consisting of movies and music.

17. The method of claim 11, wherein the user is a first time user.

18. The method of claim 11, wherein the user is an artificial intelligence.

19. A system that provides recommendations, comprising:
means for receiving an input from a user in response to an inquiry related to a group of items; and
means for creating a recommendation engine based on the received input, the engine adaptively determining subsequent maximized diverse user inquiries based on prior user inputs to learn user preferences to provide recommendations of items from the group of items.

20. The system of claim 19, further comprising:
means for obtaining parameters related to the group of items to assist with determining inquiries.
